(19) United States
(12) Patent Application Publication
(10) Pub. No.: US 2016/0219851 A1
(43) Pub. Date: Aug. 4, 2016

(54) Cast Net Mouth Grip

(71) Applicant: Eric Lane, Gainesville, FL (US)

(72) Inventor: Eric Lane, Gainesville, FL (US)

(21) Appl. No.: 14/613,444

(22) Filed: Feb. 4, 2015

(51) Int. Cl. A01K 75/00; A01K 97/00; A01K 74/00

(52) U.S. Cl. CPC A01K 75/00; A01K 74/00; A01K 97/00

(57) ABSTRACT

A flexible flap is secured to the perimeter of a conventional cast net and is configured to be grasped by a human user's mouth and teeth. The device includes mating jaw portions configured to accept and be secured to a perimeter cord of a cast net.

### BACKGROUND

The present invention pertains to nets that are manually thrown or “cast” by a user for the purpose of capturing fish or similar marine or aquatic life. In particular, the invention regards devices to enable users of such cast nets to hold and release a cast net in normal use.

Cast nets, often also called throw nets, are widely used around the world to capture fish in shallow waters. These nets are typically relatively small in size as they are thrown by hand and are limited by the strength of the user. Most typically, cast nets are circular in overall shape and may be as small as 4 feet in diameter or as large as 20 feet in diameter when fully open. These nets are deployed by grasping and then throwing the perimeter of the net in a manner to open and extend the perimeter of the net as large as possible to cover as large an area (over the water) as possible. Because larger nets are much larger that a human user's body dimensions, a user cannot easily grasp more than a small portion of these nets in the course of this action. As a result, various methods and devices have been developed to assist users and enable a more effective casting of a net. In a very common method, a user grips a portion of net perimeter in the user's mouth to retain it momentarily as the user's hands spread remaining portions of the perimeter away from the user's body and over the targeted water area. The net portion in the user's mouth is released as the net moves away from the user. It is known for a user to accidentally allow a portion of the netting to slip behind the user's teeth while gripping the net perimeter in the mouth. Upon casting and release of the net, the engaged teeth of the user may be pulled from the user's mouth by the weight and force of the falling net. This risk is inherent for those using this method. What is needed and desired is a method of grasping a cast net with a user's teeth while not endangering the user.

### SUMMARY OF THE INVENTION

The invention is a flexible flap that is secured to the perimeter of a conventional cast net and is configured to be grasped by a human user's mouth and teeth. A preferred design includes mating jaw portions configured to receive and be secured onto a perimeter cord of a cast net.

Other novel aspects and advantages of the invention are made clear by the following discussion of details of specific embodiments of the invention and claims.

### DESCRIPTION OF THE DRAWINGS

FIG. 1 is plan view of one embodiment of the invention secured to a convention cast net.

FIG. 2 is a detailed view the configuration of FIG. 1.

FIGS. 3A and 3B are, respectively, a side view and top view of the inventive device.

FIG. 4 is a side section view of the inventive device.

### DETAILS OF EMBODIMENTS OF THE INVENTION

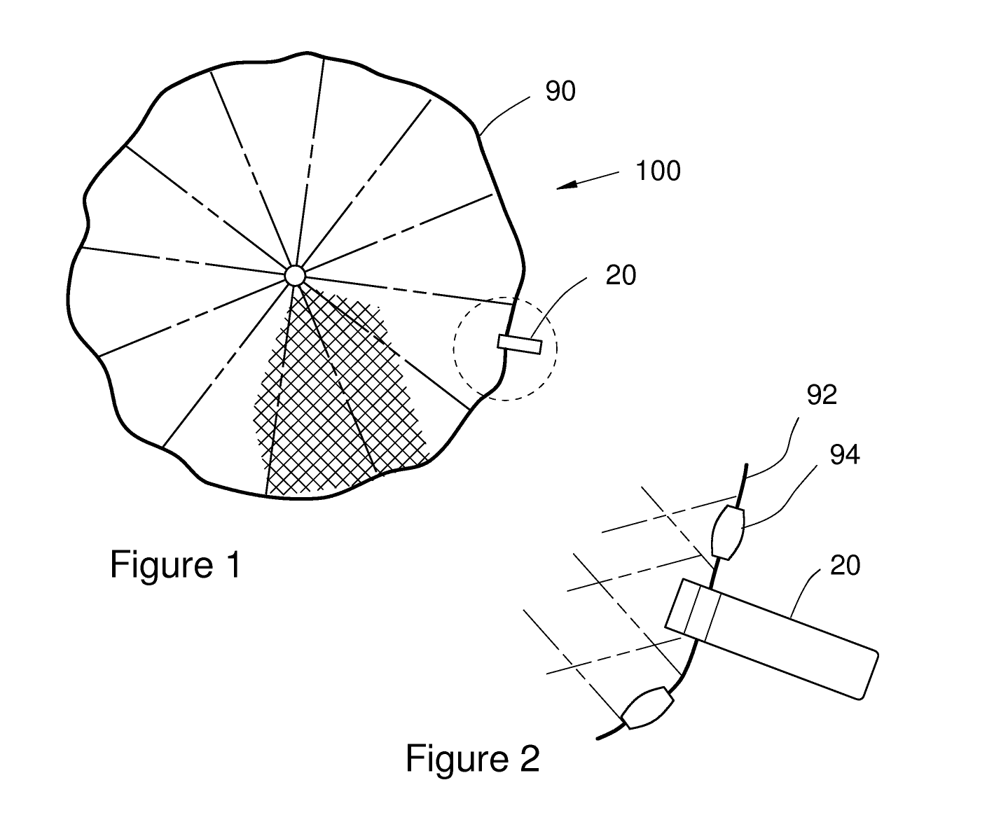

FIG. 1 is plan view of one embodiment of the invention secured to a convention cast net 100. The cast net may have any of many conventional configurations that are intended to be thrown or “cast” by hand. Some conventional elements of nets are not included in the figure as they are unimportant to explanation and understanding of the invention. Most cast nets are circular in overall shape and include a perimeter rope 92 (cord, cable) that is typically much larger (in diameter) and stronger than the net material and is attached to the net 100 at the perimeter 90 of the net. Typically a number of individual weights 94 are threaded onto or attached to the rope 92.

FIG. 2 is a expanded detailed view of the configuration of FIG. 1 illustrating one embodiment of the inventive mouth grip 20 attached to the perimeter rope 92 between adjacent cast net weights 94. The construction of the mouth grip 20 enables secure and strong attachment to the rope 92 after construction of the cast net 100. This is important in part to allow use of the inventive mouth grip 20 on existing cast nets. As illustrated, the mouth grip 20 includes an elongated flap 22 that extends outward from the perimeter rope 92. This configuration enables a user to grasp the mouth grip 20 in the users mouth and teeth.

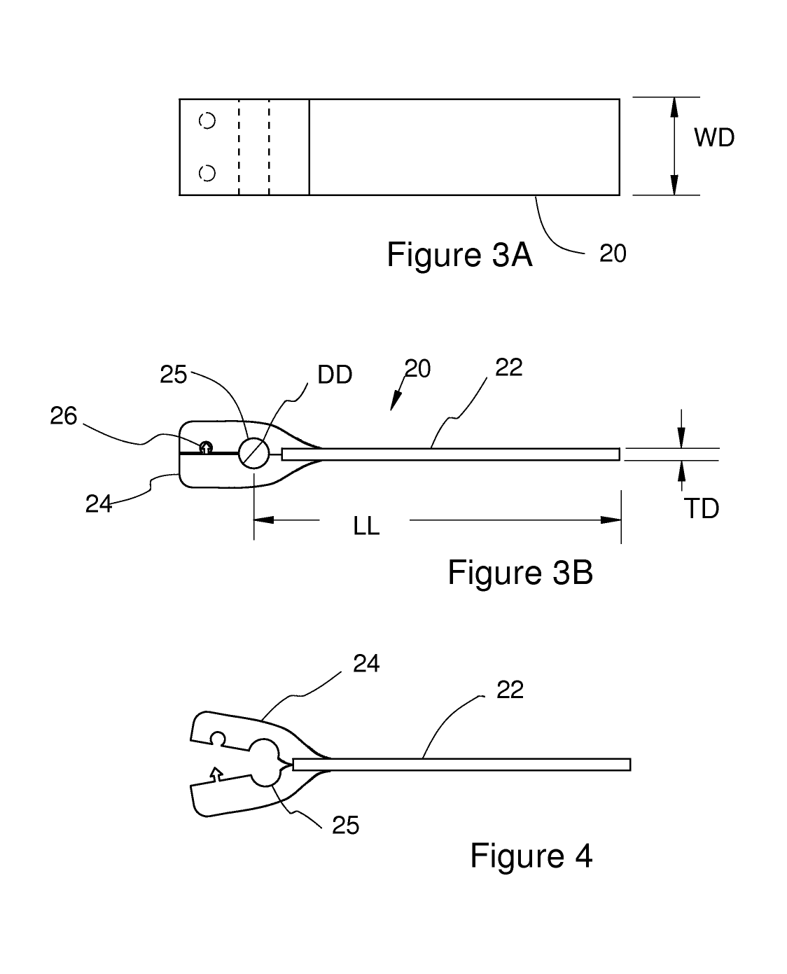

FIGS. 3A and 3B are side and top views of the mouth grip 20 and FIG. 4 is a side section view of the device, shown separate from an associated net. The device preferably has an overall length of about 5 ½ (5.5) inches. This length accommodates the portions that secure to a net perimeter rope 92 and allow for sufficient length of mouth flap 22. The mouth flap 22 preferably has effective length LL, from the perimeter cord 25 to the distal end of the mouth flap 22, in the range of three to six (3 to 6) inches and most preferably LL is 4.5 inches. If the mouth flap were too short (LL substantially less than the recommended dimension), two problems will arise in use. First, the user would have insufficient grasp of the mouth flap in the user's mouth, and as well the perimeter rope 92 and the attached weights 94 would be retained too close to the user while holding the mouth grip 22 such as to injure the user's mouth, neck or face. A mouth flap 22 that has a length substantially greater than that recommended provides insufficient control of the cast net while in the act of throwing.

The mouth flap 22 has a width dimension WD (orthogonal to the length LL) in the range of 1.5 to two inches. This WD dimension is required to provide sufficient grip while accommodating the limited size of a human user's mouth.

The mouth flap 22 must have a thickness dimension TD sufficient for gripping by a user's mouth and teeth and to prevent tearing of the flap 22. The thickness TD should be in the range of ⅛ to ¼ inches for these purposes. Thicknesses substantially outside this range will not allow a user to properly grip the mouth flap in use.

At one end of the mouth flap 22 is an attachment head 24 configured for attaching the mouth flap 22 to a net perimeter rope 92. The attachment head 24 may be integral with the mouth flap 22 or separate but secured to it. The attachment head 24 may have any of a variety of configurations and constructions that provide the same essential function as that illustrated and discussed here.

The attachment head 24 includes a transverse passage 25 extending entirely through the attachment head 24, from side to side. The passage 25 is shown as having a round cross-section but this is not limiting and other shaped cross-sections will function. The diameter, or equivalent nominal size, of the passage 25 is designed to accept a predetermined diameter perimeter cord in a slight compression fit. The perimeter cord in most applicable cast nets have a diameter about ¼ inch for nets that benefit most from use of the inventive device. The diameter dimension DD, or equivalent nominal size, of a respective attachment head passage would be slightly less to establish a compression fit when secured in place.

The attachment head 24 preferably has a “clam-shell” contrustion and is split through the center of the passage 25 such that the two portions of the attachment head 24 may be pivoted open, to allow a cast net perimeter cord to be inserted transversely into the attachment head 24 to reside within the passage 25. In this way the mouth grip 20 may be secured to a cast net. After insertion of the perimeter cord, the two portions of the attachment head 24 are fastened together, within the cast net perimeter, by means of two or more snap fasteners 26. The snap fasteners 26 should be distanced from the passage 25 to allow the fastener elements to pass on the inside of the perimeter, without damaging the perimeter cord. The attachment head 24 may be so fastened using any of a variety of other devices and methods including, but not limited to, threaded fasteners, through-hole threaded fasteners and the like.

To perform the above functions and securely retain a cord within the passage 24, the attachment head is preferably formed of one a variety of high strength plastics such as PVC, nylon, delron or the like. However, other equivalent material may be used. Most preferably, the material is corrosion resistant and impervious to water.

The mouth flap 22 must be formed of a flexible yet tough and resilient material. Proper flexibilty can be judged by the ability to easily bend and roll the mouth flap 22 (sized as suggested) into a circle, bringing opposite ends together, and upon release readily return to its original shape. As well, the mouth flap 22 must be sufficiently soft to allow gripping by a user's mouth and teeth without damage to the user. An preferred material will have a hardness in the range of 75 to 81 on the Shore A scale (ASTM 2240). Extruded soft PVC vinyl (polyvinyl chloride) sheet is an exemplary material. Rigid materials are unacceptable and will result in injury to the user.

Other novel aspects of the invention will be clear from inspection of the associated drawing figures and the below claims.

1. A cast net grip for grasping by a human user' teeth, comprising:
an attachment head having a transverse passage configured to be secured a elongated cord;
an elongated flap extending from the attachment head and having a distal end and having a length dimension from the passage to the distal end in the range of three to six inches; and
the flap comprising a soft and flexible material.

2. A cast net grip for grasping by human user's teeth, comprising:
an elongated flap having a length dimension in the range of three to six inches, the flap comprising a soft and flexible material; and
means of securing the flap to a cast net perimeter cord.

3. An improved cast net having a perimeter cord, wherein the improvement comprises:
an elongated flap secured to the perimeter cord and having a length dimension, from the perimeter cord to a flap distal end, in the range of three to six inches; and
the flap comprising a soft and flexible material.

4. An improved cast net, according to claim 3, and wherein:
the flap has a width dimension in the range of 1.5 to 2 inches.
